(19) United States
(12) Patent Application Publication
(10) Pub. No.: US 2014/0225466 A1
(43) Pub. Date: Aug. 14, 2014

(54) BRUSHLESS MOTOR, ELECTRICAL ACTUATOR AND DRIVING DEVICE FOR OPENING AND CLOSING BODY FOR VEHICLE

(71) Applicant: Aisin Seiki Kabushiki Kaisha, Kariya-shi (JP)

(72) Inventor: Takemitsu SUMIYA, Kariya-shi (JP)

(73) Assignee: Aisin Seiki Kabushiki Kaisha, Kariya-shi (JP)

(21) Appl. No.: 14/081,638

(22) Filed: Nov. 15, 2013

(30) Foreign Application Priority Data
Feb. 14, 2013 (JP) 2013-026693

(51) Int. Cl. H02K 3/28; H02K 7/116

(52) U.S. Cl. CPC H02K 3/28; H02K 7/116
USPC 310/83; 310/198

(57) ABSTRACT

A brushless motor includes a magnet rotor including a rotary shaft to be rotatable about the rotary shaft, a stator including plural teeth facing against the magnet rotor, plural drive coils being wound around the teeth and being supplied with a three-phase drive power to rotate the magnet rotor, and plural holding coils being wound around the teeth and including an independently-arranged power supply line, in which the holding coils are arranged to generate an electromagnetic attractive force to maintain the magnet rotor at a rotational position where ends of the teeth around which the holding coils are wound and a magnetic pole of the magnet rotor are configured to directly face against one another by supplying electricity to the holding coils via the power supply line.

### CROSS-REFERENCE TO RELATED APPLICATIONS

This application is based on and claims priority under 35 U.S.C. §119 to Japanese Patent Application 2013-026693, filed on Feb. 14, 2013, the entire content of which is incorporated herein by reference.

### TECHNICAL FIELD

This disclosure generally relates to a brushless motor, an electrical actuator and a driving device for an opening and closing body for a vehicle.

### BACKGROUND DISCUSSION

A known electrical actuator configured with a motor as a drive source is required to include conflicting functions to maintain a stopping position of a drive object while allowing the drive object to be operated freely and smoothly by an external input. For example, a door opening and closing device for a vehicle including a power sliding door is required to maintain an opening position to restrict a vehicle door from moving by a weight of the vehicle door while allowing the vehicle door to be moved by a manual operation smoothly.

As disclosed in JP2010-24829A (hereinafter referred to as Patent reference 1), according to an aforementioned use, the stopping position of the drive object may be maintained by including a drive force transmission system which does not permit or hardly performs a reverse input operation by, for example, applying a worm gear as a speed reduction mechanism. As disclosed in Patent reference 1, a configuration of the electrical actuator which allows a free operation of the drive object by releasing a clutch mechanism that is mounted to the drive force transmission system is considerable.

Alternatively, a method to generate an electromagnetic braking force by a motor control may be adopted. According to a disclosure disclosed in JP2005-57962A (hereinafter referred to as Patent reference 2) applying a brushless motor as a drive source, a stopping position of a drive object is maintained by restricting a rotation of the brushless motor by executing a braking control that applies an energization of fixed phase (fixed-phase energization control). In this case, a drive force transmission system that allows a reverse input operation by an external input is formed. Then, by terminating the braking control and releasing the maintenance of the stopping position of the drive object, free and smooth operation of the drive object may be secured.

However, according to Patent reference 1, the size of the device is increased by mounting the clutch mechanism to the electrical actuator.

According to Patent reference 2, the braking control by the fixed-phase energization control regulates the rotation of a rotor by balancing an attractive force and a repulsive force caused between teeth and the rotor that configure a stator by supplying electricity to a motor coil. Thus, in fact, a maintaining force cannot be necessarily generated efficiently. Further, the motor coil generates heat when the drive object is maintained at the stopping position for a long time.

A need thus exists for a brushless motor, an electrical actuator and a driving device for an opening and closing body for a vehicle which are not susceptible to the drawback mentioned above.

### SUMMARY

According to an aspect of this disclosure, a brushless motor includes a magnet rotor including a rotary shaft to be rotatable about the rotary shaft, a stator including plural teeth facing against the magnet rotor, plural drive coils being wound around the teeth and being supplied with a three-phase drive power to rotate the magnet rotor, and plural holding coils being wound around the teeth and including an independently-arranged power supply line, in which the holding coils are arranged to generate an electromagnetic attractive force to maintain the magnet rotor at a rotational position where ends of the teeth around which the holding coils are wound and a magnetic pole of the magnet rotor are configured to directly face against one another by supplying electricity to the holding coils via the power supply line.

According to an aspect of this disclosure, an electrical actuator includes a brushless motor including a magnet rotor including a rotary shaft to be rotatable about the rotary shaft, a stator including plural teeth facing against the magnet rotor, plural drive coils being wound around the teeth and being supplied with a three-phase drive power to rotate the magnet rotor, and plural holding coils being wound around the teeth and including an independently-arranged power supply line, in which the holding coils are arranged to generate an electromagnetic attractive force to maintain the magnet rotor at a rotational position where ends of the teeth around which the holding coils are wound and a magnetic pole of the magnet rotor are configured to directly face against one another by supplying electricity to the holding coils via the power supply line, and a speed reduction mechanism decelerating a rotation of the brushless motor for an output and transmitting a reverse input rotation inputted from an output portion of the speed reduction mechanism to an input portion of the speed reduction mechanism, the input portion connected to the brushless motor.

According to an aspect of this disclosure, a driving device for an opening and closing body for a vehicle includes an electrical actuator including a brushless motor including a magnet rotor including a rotary shaft to be rotatable about the rotary shaft, a stator including plural teeth facing against the magnet rotor, plural drive coils being wound around the teeth and being supplied with a three-phase drive power to rotate the magnet rotor, and plural holding coils being wound around the teeth and including an independently-arranged power supply line, in which the holding coils are arranged to generate an electromagnetic attractive force to maintain the magnet rotor at a rotational position where ends of the teeth around which the holding coils are wound and a magnetic pole of the magnet rotor are configured to directly face against one another by supplying electricity to the holding coils via the power supply line, and a speed reduction mechanism decelerating a rotation of the brushless motor for an output and transmitting a reverse input rotation inputted from an output portion of the speed reduction mechanism to an input portion of the speed reduction mechanism, the input portion connected to the brushless motor, in which the opening and closing body for a vehicle is operated to be open and closed.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic configuration view of a power sliding door system;

FIG. 2 is a cross-sectional view of an electrical actuator according to the disclosure disclosed here;

FIG. 3 is a partially-enlarged cross-sectional view of the electrical actuator according to the disclosure;

FIG. 4 is a schematic configuration view of a brushless motor of a first embodiment;

FIG. 5 is a waveform diagram illustrating output properties of the brushless motor of the first embodiment;

FIG. 6 is a perspective view of a magnet rotor and a pinion gear configuring an input portion of a speed reduction mechanism according to the disclosure;

FIG. 7 is a flow chart illustrating a process of braking control (maintaining control) for a sliding door by supplying electricity to holding coils according to the disclosure;

FIG. 8 is a schematic configuration view of a brushless motor of a second embodiment;

FIG. 9 is a schematic configuration view of a brushless motor of a third embodiment;

FIG. 10 is an explanatory view illustrating the holding coil and a power supply line of the brushless motor according to the third embodiment;

FIG. 11 is an explanatory view schematically illustrating another example of teeth arranged at the brushless motor of the second embodiment; and

FIG. 12 is an explanatory view illustrating another example of the holding coil and the power supply line of the brushless motor according to the third embodiment.

### DETAILED DESCRIPTION

An electrical actuator 11 of a power sliding door system 20 (serving as a driving device for an opening and closing body for a vehicle) and a brushless motor 10 which is a drive source of the electrical actuator 11 according to a first embodiment will be described referring to figures.

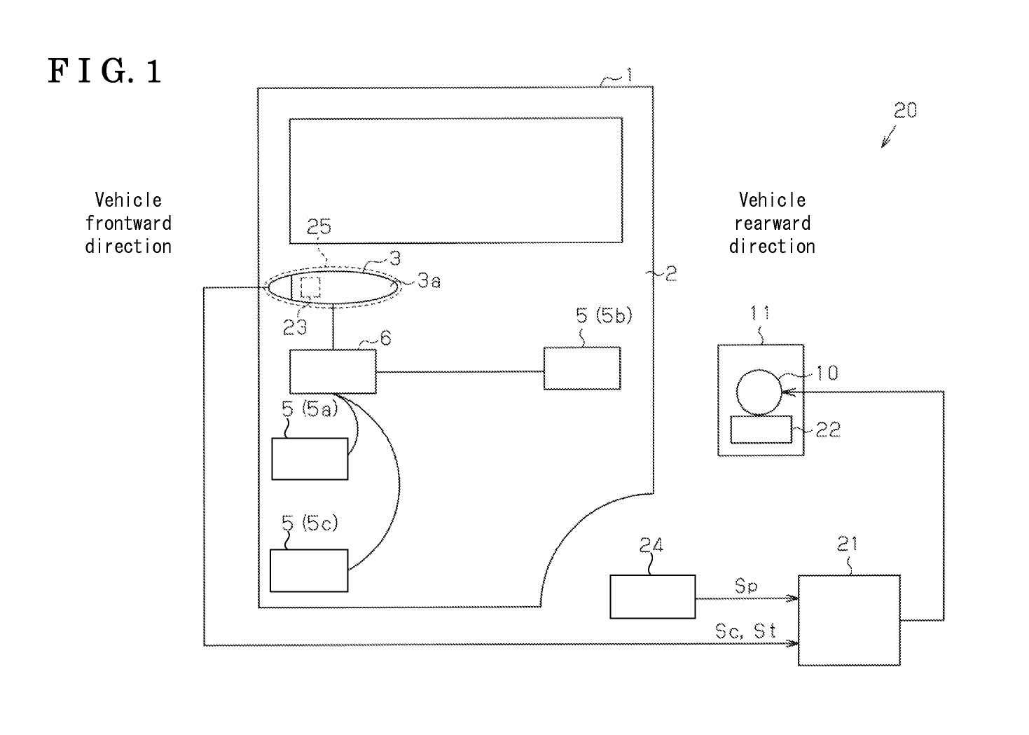

As illustrated in FIG. 1, a sliding door 1 as an opening and closing body mounted to a vehicle is configured to move in a vehicle frontward-rearward direction to open and close an opening portion arranged at a side surface of the vehicle body. Specifically, a closed state of the sliding door 1, the state where the opening portion of the vehicle body is closed, is established when the sliding door 1 moves in the vehicle frontward direction (left in FIG. 1). An open state allowing occupants to get on or off via the opening portion of the vehicle body is established when the sliding door 1 moves in the vehicle rearward direction (right in FIG. 1). A door handle 3, a handle device operated to open and close the sliding door 1, is mounted on an outer panel 2 configuring an outer surface (design surface) of the sliding door 1.

Specifically, the sliding door 1 includes a front lock 5a and a rear lock 5b (fully-closed lock) for maintaining the sliding door 1 at a fully-closed position. The sliding door 1 includes a fully-open lock 5c for maintaining the sliding door 1 at a fully-open position. Each of the lock mechanisms (latch mechanisms) 5 is connected mechanically to the door handle 3 via a transmission member including a wire extending from a remote controller 6.

In particular, the door handle 3 includes a movable hand grip 3a and an operation input to the door handle 3 is transmitted to each of the rock mechanisms 5 in response to an operation of the hand grip 3a configuring a gripping portion of the door handle 3. The hand grip 3a includes a known configuration such that a front end portion (end portion in the vehicle frontward direction) of the hand grip 3a is pulled up when the hand grip 3a is operated in the vehicle rearward direction which is an opening direction of the sliding door 1. When the restriction, or maintenance, of the sliding door 1 is released in response to an operating force applied to the hand grip 3a, the sliding door 1 positioned at the fully-closed position may be moved in the opening direction while the sliding door 1 positioned at the fully-open position may be moved in the closing direction.

Further, the power sliding door system 20 is mounted to the vehicle. The power sliding door system 20 includes an electrical actuator 11 configuring with the brushless motor 10 as a drive source to open and close the sliding door 1.

Specifically, according to the power sliding door system 20 of the first embodiment, the brushless motor 10 rotates in response to driving power of three phases (U, V, W) supplied by the control device 21. The operation of the electrical actuator 11 is controlled by the control device 21 that supplies power to the brushless motor 10.

The electrical actuator 11 includes a speed reduction mechanism 22 that decelerates the rotation of the brushless motor 10 for an output. According to the first embodiment, the power sliding door system 20 opens and closes the sliding door 1 when the rotation of the brushless motor 10 decelerated by the speed reduction mechanism 22 is transmitted to a driving portion of the sliding door 1.

More specifically, the door handle 3 of the first embodiment includes a contact-type operation detection switch 23 operating in response to the operation of the hand grip 3a. The control device 21 detects whether the operation is inputted to the door handle 3 in response to an operation input signal Sc outputted by the operation detection switch 23. The control device 21 is connected to an operation position sensor 24 and detects an operation position (opening and closing position) of the sliding door 1 in response to an output signal (an operation position signal Sp) of the operation position sensor 24. The control device 21 detects a contact state of the door handle 3 in response to an output signal (a contact signal St) of a touch sensor 25 mounted on the door handle 3. A known electrostatic capacitance-type contact sensor is applied to the touch sensor 25. The control device 21 controls the operation of the electrical actuator 11 to open and close (and to stop the operation of) the sliding door 1 in response to the detected operation input to the door handle 3, the detected operation position of the sliding door 1 and the contact state of the door handle 3.

Next, the configurations of the electrical actuator 11 and the brushless motor 10 as the drive source of the electrical actuator 11 both configuring the power sliding door system 20 will be described.

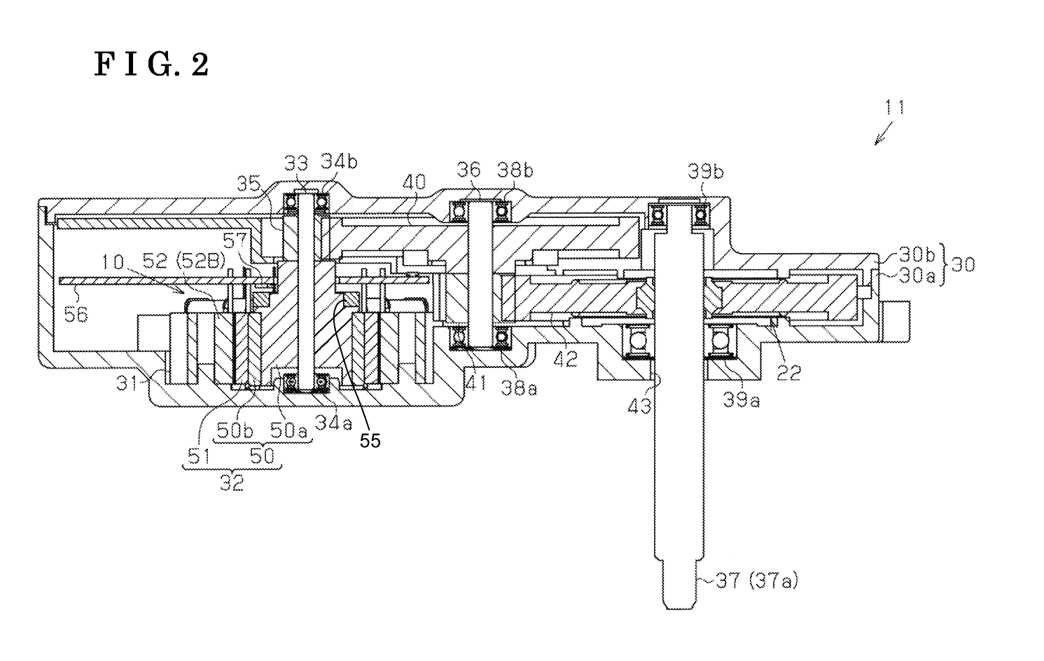

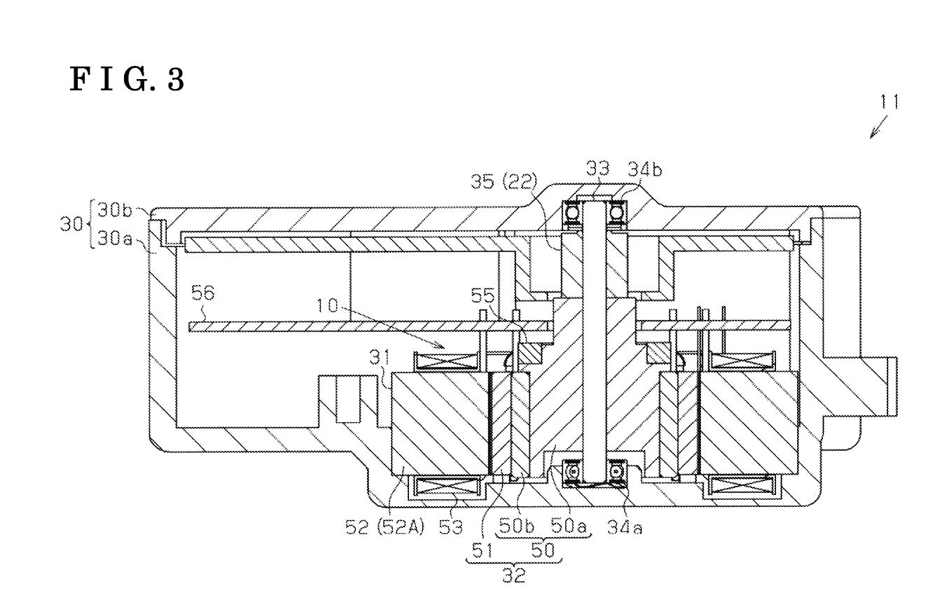

As illustrated in FIGS. 2 and 3, the electrical actuator 11 of the first embodiment includes a flattened, substantially box-shaped housing 30. The brushless motor 10 and the speed reduction mechanism 22 are accommodated in the housing 30.

Specifically, the housing 30 of the first embodiment is formed by assembling a first housing member 30a with a second housing member 30b. The brushless motor 10 includes a stator 31 and a magnet rotor 32. The stator 31 is fixed on the first housing member 30a. The magnet rotor 32 is rotatably supported inside the stator 31.

According to the first embodiment, opposing ends of a first rotary shaft 33 (serving as a rotary shaft) of the magnet rotor 32 are axially supported by a first bearing 34a and a second bearing 34b, arranged at the first housing member 30a and the second housing member 30b, respectively. A first pinion gear 35 (serving as an input portion) integrally rotated with the magnet rotor 32 is fixed on the first rotary shaft 33. The speed reduction mechanism 22 of the first embodiment including the first pinion gear 35 as an input portion of the speed reduction mechanism 22 is formed by plural disc-shaped gears being meshed with one another.

Specifically, as illustrated in FIG. 2, two rotary shafts, a second rotary shaft 36 and a third rotary shaft 37 are arranged in parallel with the first rotary shaft 33 of the magnet rotor 32 inside the housing 30. The second rotary shaft 36 is axially supported by a third bearing 38a arranged at the first housing member 30a and by a fourth bearing 38b arranged at the second housing member 30b. The third rotary shaft 37 is axially supported by a fifth bearing 39a arranged at the first housing member 30a and by a sixth bearing 39b arranged at the second housing member 30b. A first helical gear 40 and a second pinion gear 41 are fixed on the second rotary shaft 36. The first helical gear 40 meshes with the first pinion gear 35 arranged at the first rotary shaft 33 of the magnet rotor 32. The second pinion gear 41 integrally rotates with the first helical gear 40. A second helical gear 42 is fixed on the third rotary shaft 37. The second helical gear 42 meshes with the second pinion gear 41 arranged at the second rotary shaft 36. The speed reduction mechanism 22 of the first embodiment is configured such that an end 37a (serving as an output portion) of the third rotary shaft 37 protrudes to the outside of the housing 30 via a through hole 43 formed at the first housing member 30a.

That is, the speed reduction mechanism 22 of the first embodiment is configured such that the end 37a of the third rotary shaft 37 protruding to the outside of the housing 30 performs, or serves as an output portion (output shaft) of the speed reduction mechanism 22. Based on a difference between the numbers of teeth of the first pinion gear 35 and the first helical gear 40 that are meshed with one another as well as a difference between the numbers of teeth of the second pinion gear 41 and the second helical gear 42 that are meshed with one another, the rotation of the brushless motor 10 (the rotation of the magnet rotor 32) is decelerated for the output.

More specifically, according to the brushless motor 10 of the first embodiment, as illustrated in FIGS. 2 and 3, the magnet rotor 32 includes a rotor core 50 fixed on the first rotary shaft 33. The rotor core 50 of the first embodiment includes an inner contour portion 50a fixed on the first rotary shaft 33 and an outer contour portion 50b fixed on an outer circumference of the inner contour portion 50a. A first ring magnet 51, which is a permanent magnet, is fixed on an outer circumference of (the outer contour portion 50b of) the rotor core 50. The stator 31 includes plural teeth 52 arranged at positions to surround the magnet rotor 32 so that ends (radially inner ends) of the teeth 52 which are configured to face against an outer circumferential surface of the magnet rotor 32.

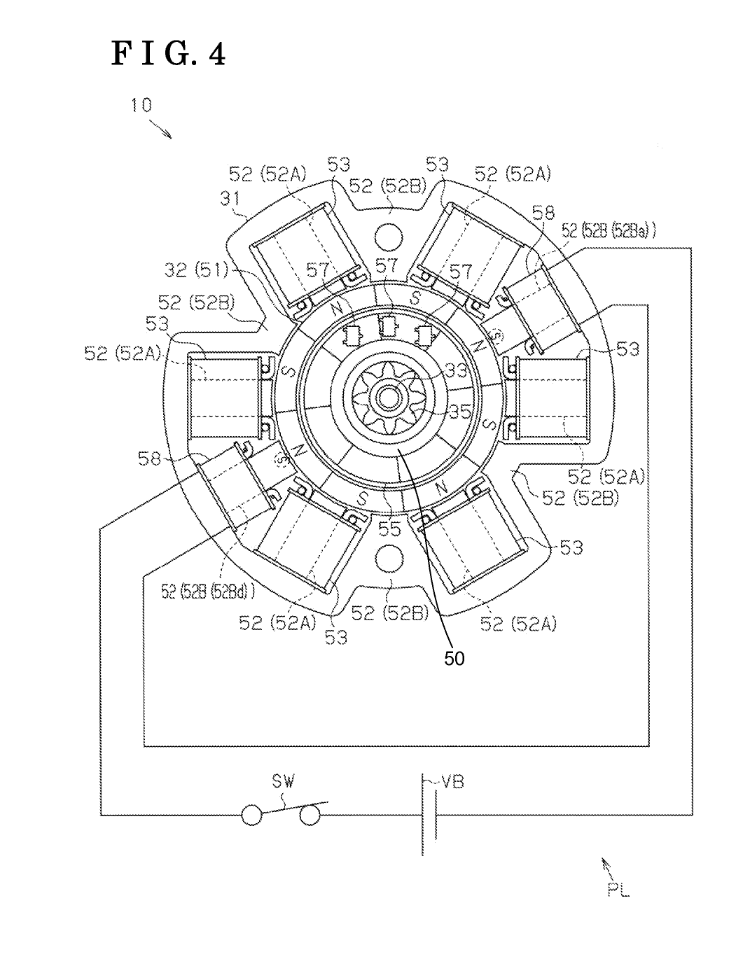

As illustrated in FIG. 4, the stator 31 of the first embodiment includes first teeth 52A and second teeth 52B. The first teeth 52A are wound with drive coils 53 to which the three-phase drive power is supplied to rotate the magnet rotor 32. The second teeth 52B are not wound with the drive coils 53.

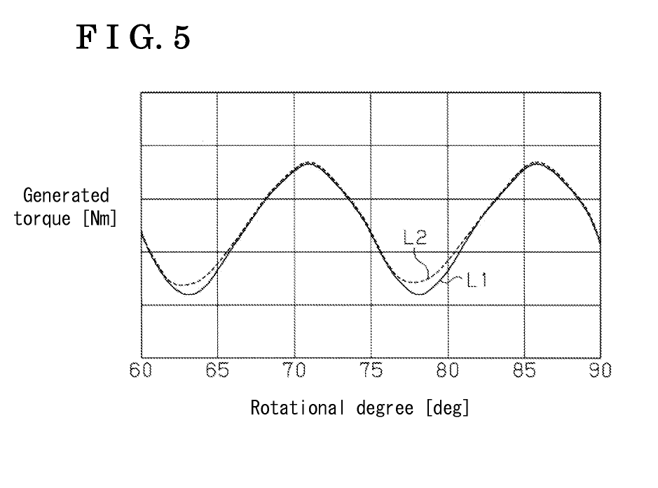

Specifically, the first teeth 52A and the second teeth 52B are arranged alternately in the circumferential direction of the stator 31 to surround an outer circumference of the magnet rotor 32. That is, by supplying the three-phase drive power outputted by the control device 21 to the drive coils 53, a magnetic circuit that extends through each of the first teeth 52A around which the drive coil 53 is wound and the second teeth 52B adjacent to the first teeth 52A is formed. According to the first embodiment, as illustrated in FIG. 5, output properties (for example, motor torque or torque ripple) of the brushless motor 10 substantially the same as output properties of a known brushless motor in which drive coils (motor coils) are wound around all teeth are obtained.

As illustrated in FIG. 5, a wave pattern L1 in a solid line illustrating a relation of a generated torque of the brushless motor 10 and a rotational degree, or a rotational angle of the magnet rotor 32 of the first embodiment is closer to a sine wave than a wave pattern L2 in a broken line illustrating a relation of a generated torque of a known brushless motor and a rotational degree, or a rotational angle of a known magnet rotor. According to the first embodiment, the brushless motor 10 obtains improved output properties with a reduced torque ripple.

According to the first embodiment, as illustrated in FIGS. 2 and 3, a second ring magnet 55 is fixed on an end surface in an axial direction of (the inner contour portion 50a of) the rotor core 50. The end surface in the axial direction of the rotor core 50 corresponds to the upper end surface of the rotor core 50 in the axial direction of the first rotary shaft 33 illustrated in FIG. 3. In the housing 30, a control circuit board 56 is arranged in the axial direction of the magnet rotor 32 directly facing against the second ring magnet 55. The control circuit board 56 includes hole ICs 57 for detecting the rotational degree, or the rotational angle of the magnet rotor 32 in response to a change in the magnetic flux.

Further specifically, as illustrated in FIG. 4, the brushless motor 10 of the first embodiment is formed as Surface Permanent Magnet motor, or SPM motor including the surface magnet-type magnet rotor 32. For example, eight magnetic poles including both North poles and South poles are formed on the first ring magnet 51 fixed on an outer circumferential surface of the rotor core 50. The eight magnetic poles are formed by magnetizing the first ring magnet 51 (the number of pairs of the magnetic poles is, for example, four, with the N pole and the S pole being in a pair).

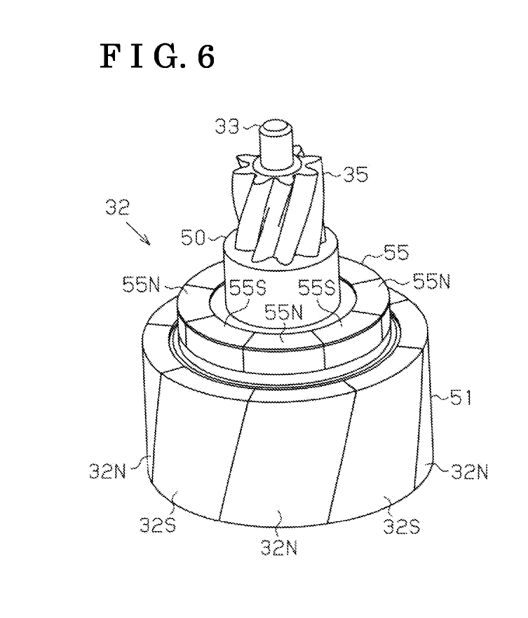

In particular, as illustrated in FIG. 6, a skew magnetization is applied to each of magnetic poles (32N, 32S) of the magnet rotor 32 formed by the first ring magnet 51. According to the first embodiment, the skew magnetization reduces cogging torque of the magnet rotor 32. The skew magnetization is not applied to each of magnetic poles (55N, 55S) of the second ring magnet 55 applied for detecting the rotational degree, or the rotational angle of the magnet rotor 32.

As illustrated in FIG. 4, the stator 31 includes, for example, twelve, teeth 52 arranged to be spaced at equal angular intervals (intervals of 30 degrees) in the circumferential direction of the stator 31. That is, the stator 31 includes, for example, six each of the first teeth 52A and the second teeth 52B arranged alternately in the circumferential direction of the stator 31. The second teeth 52Ba, 52Bd arranged at positions spaced one another at 180 degrees in the circumferential direction of the stator 31 are wound with holding coils 58 including an independently-arranged power supply line PL. The power supply line PL is independently arranged from a known power supply line supplying three-phase drive power to the drive coils 53.

Specifically, according to the first embodiment, Direct Current power, or DC power of Direct Current power supply VB, or DC power supply VB is supplied to the holding coils 58 by turning on a switch SW provided at the power supply line PL. According to the first embodiment, by supplying electricity to the holding coils 58, S pole is formed at the radially inner ends of the second teeth 52Ba, 52Bb around which the holding coils 58 are wound. The rotation of the magnet rotor 32 may be restricted in response to an attractive force (electromagnetic attractive force) of a magnetic pole (S pole) formed at the radially inner ends of the second teeth 52Ba, 52Bd and a magnetic pole (N pole) of the magnet rotor 32.

That is, according to the brushless motor 10 of the first embodiment, the number of pairs of the magnetic poles of the magnet rotor 32 is, for example, four, while the number of the teeth 52 arranged at the stator 31 is, for example, twelve, which is a multiple number (three times) of four. The number of the second teeth 52B is, for example, six, which is a half of twelve. The second teeth 52Ba, 52Bd around which the holding coils 58 are wound are positioned to be spaced at 180 degrees in the circumferential direction of the stator 31. Thus, the radially inner ends of the second teeth 52Ba, 52Bd are configured to directly face against the magnetic pole of the magnet rotor 32 concurrently, or simultaneously. According to the first embodiment, the electromagnetic attractive force is generated to maintain the magnet rotor 32 at a rotational position of the magnet rotor 32, the rotational position where the radially inner ends of the second teeth 52Ba, 52Bd and the magnetic pole (N pole) of the magnet rotor 32 are configured to directly face against one another.

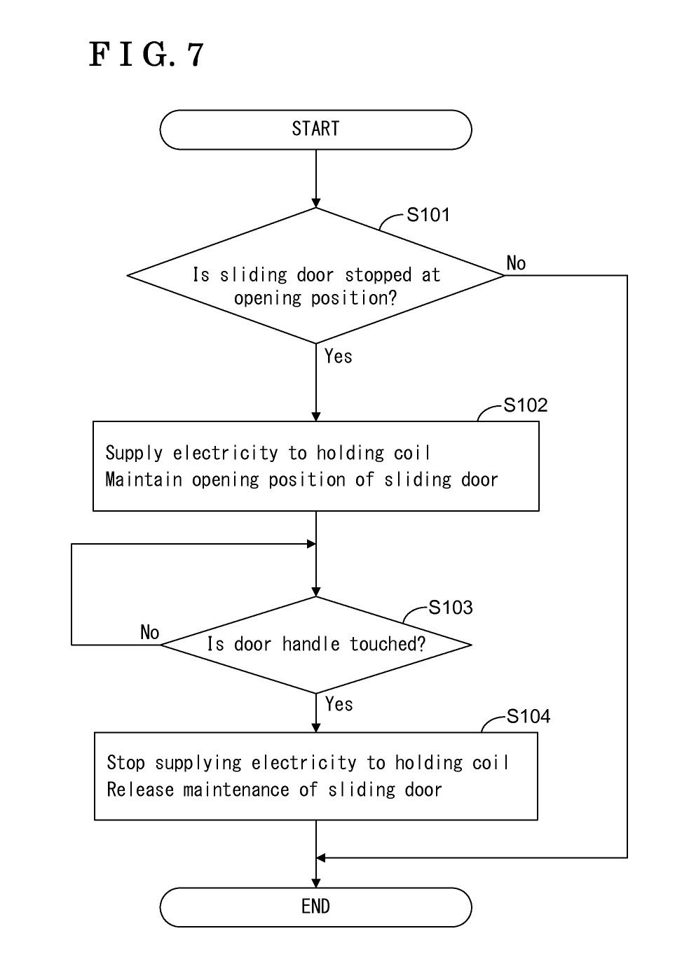

Next, an operation of the power sliding door system 20 of the first embodiment configured as above will be described. As illustrated in a flowchart in FIG. 7, the control device 21 of the first embodiment controls power supply to turn on the switch SW provided at the power supply line PL in a case where the control device 21 determines that the sliding door 1, the drive object of the electrical actuator 11, stops at any opening positions except for the full-opening position (YES at Step S101).

That is, by supplying (energizing) DC power to the holding coils 58 of the brushless motor 10, the magnetic pole (S pole) is formed at the radially inner ends of the second teeth 52Ba, 52Bd around which the holding coils 58 are wound. Further, by generating the electromagnetic attractive force between the magnetic pole (S pole) of the second teeth 52Ba, 52Bd and the magnetic pole (N pole) of the magnet rotor 32 to attract one another, the rotation of the magnet rotor 32, that is, the rotation of the brushless motor 10 is restricted. According to the first embodiment, a stopping position of the sliding door 1 is maintained by restricting the rotation of the brushless motor 10 (Step S102).

In a case where the stopping position of the sliding door 1 is maintained by supplying electricity to the holding coils 58, the control device 21 determines whether an occupant touches the door handle 3 in response to a touch signal St inputted from the touch sensor 25 (Step S103). In a case where the control device 21 determines that the occupant touches the door handle 3 (YES at Step S103), the control device 21 controls power supply to turn off the switch SW provided at the power supply line PL.

Thus, by stopping supplying electricity to the holding coils 58, the brushless motor 10 as a drive source of the electrical actuator 11 can rotate freely. According to the first embodiment, as the sliding door 1 moves freely, the occupant can manually open and close the sliding door 1 smoothly (Step S104).

According to the first embodiment, following effects and advantages may be attained.

First, the brushless motor 10 includes the magnet rotor 32, the stator 31 and the drive coils 53. The magnet rotor 32 is rotatably supported by the first rotary shaft 33. The stator 31 includes the plural teeth 52 whose radially inner ends are configured to face against the magnet rotor 32. The drive coils 53 are wound around the teeth 52 and supplied with the three-phase drive power to rotate the magnet rotor 32. The brushless motor 10 includes the holding coils 58 that is provided with the independently-arranged power supply line PL and wound around the teeth 52. The holding coils 58 are arranged to generate the electromagnetic attractive force that holds, or retains the magnet rotor 32 at the rotational position where the radially inner ends of the teeth 52 (52Ba, 52Bd) around which the holding coils 58 are wound and the magnetic pole (N pole) of the magnet rotor 32 directly face with one another.

That is, the electromagnetic attractive force attracting the magnetic pole (S pole) formed at the radially inner ends of the teeth 52 around which the holding coils 58 are wound and the magnetic pole (N pole) of the magnet rotor 32 one another by supplying electricity to the holding coils 58 is maximized at the rotational position of the magnet rotor 32, the rotational position where the radially inner ends of the teeth 52 and the magnetic pole of the magnet rotor 32 are configured to directly face against one another. Thus, according to the aforementioned first embodiment, the stopping position of the magnet rotor 32 may be maintained by restricting the rotation of the magnet rotor 32 efficiently. The configuration of the sliding door 1 is greatly simplified compared to a configuration of a known sliding door including a mechanical lock device.

Further, by operating the aforementioned braking control applying the dedicated holding coils 58, heat caused by supplying electricity to the holding coils 58 can be refrained while maintaining a magnitude of the motor torque that can be generated. That is, an amount of the electromagnetic attractive force required to maintain the magnet rotor 32 at the stopping position has tendency to be smaller than an amount of the force required when the brushless motor 10 is in a drive state. Accordingly, the heat may be refrained from generating by presetting a large resistance value of the wire rod applied to the holding coils 58 and by keeping the amount of current flowing to the holding coils 58 low.

Second, the stator 31 is formed such that the first teeth 52A and the second teeth 52B are arranged alternately in the circumferential direction of the stator 31. The first teeth 52A are wound with the drive coils 53 supplied with the three-phase drive power to rotate the magnet rotor 32. The second teeth 52B are not wound with the drive coils 53 and are wound with the holding coils 58.

According to the configuration, compared to the known brushless motor in which motor coils are wound around all the teeth, the brushless motor 10 may reduce the number of the components and the process for winding and connecting coils while maintaining the output properties (for example, motor torque or torque ripple) substantially the same as output properties of the known brushless motor. By winding the holding coils 58 to the second teeth 52B which are not wound with the drive coils 53, the brushless motor 10 may avoid a size increase of the device caused by the winding of the holding coils 58.

Third, the stator 31 includes the teeth 52 whose number is a multiple number (for example, n=12) of the number of pairs of the magnetic poles (for example, m=4) formed at the magnet rotor 32. That is, according to the configuration, the plural teeth 52 for directly facing against the magnetic pole of the magnet rotor 32 concurrently, or simultaneously are positioned to be spaced at the equal angular intervals in the circumferential direction of the stator 31. That is, the teeth 52 are equally spaced in the circumferential direction of the stator 31. Thus, by winding the holding coils 58 to the teeth 52 that are configured to directly face against the magnetic pole of the magnet rotor 32 concurrently, or simultaneously, the electromagnetic attractive force may be generated to maintain the magnet rotor 32 at the rotational position efficiently in a well-balanced manner.

Fourth, the holding coils 58 are wound around the second teeth 52Ba, 52Bd arranged to be spaced one another at 180 degrees in the circumferential direction of the stator 31. That is, as long as the number of the teeth 52 (for example, n=12) arranged at the stator 31 is a multiple number of a number of pairs of the magnetic poles (for example, m=4) formed at the magnet rotor 32, each of the plural teeth 52 arranged to be spaced at a degree interval (90 degrees) corresponding to a value obtained by dividing single rotation degrees (360 degrees) of the magnet rotor 32 by the number of pairs of the magnetic poles of the magnet rotor 32 may be configured to directly face against the magnetic pole (N pole) of the magnet rotor 32 concurrently, or simultaneously. According to the brushless motor 10 of the first embodiment, because the number of the second teeth 52B is a half of the number of the teeth 52 (for example, six), for example, two of the second teeth 52B arranged to be spaced at 180 degrees in the circumferential direction of the stator 31 may be configured to directly face against the magnetic pole (N pole) of the magnet rotor 32 concurrently, or simultaneously.

Thus, according to the aforementioned structure, the electromagnetic attractive force can be generated to maintain the magnet rotor 32 at the rotational position efficiently in a well-balanced manner at, for example, two positions spaced at equal angular intervals in the circumferential direction of the stator 31, the two positions directly facing against the radially inner ends of the second teeth 52Ba, 52Bd around which the holding coils are wound and the magnetic pole of the magnet rotor 32 one another concurrently, or simultaneously.

Fifth, the electrical actuator 11 includes the brushless motor 10 as the drive source and the speed reduction mechanism 22 decelerating the rotation of the brushless motor 10 for the output. The speed reduction mechanism 22 transmits a reverse input rotation inputted from (the end 37a of) the third rotary shaft 37 of the second helical gear 42 which serves as an output portion of the speed reduction mechanism 22 to the first rotary shaft 33 of the first pinion gear 35 (or the magnet rotor 32) which serves as the input portion of the speed reduction mechanism 22, the input portion connected to the brushless motor 10.

According to the aforementioned structure, the stopping position of the sliding door 1 which is the drive object is maintained by the braking control of the brushless motor 10 by supplying electricity to the holding coils 58. Then, when the maintenance of the stopping position of the sliding door 1 is released by terminating the braking control, the sliding door 1 may also be performed by manual opening and closing operations smoothly.

Sixth, the skew magnetization is applied to each of the magnetic poles of the magnet rotor 32. The skew magnetization for each magnetic pole reduces cogging torque of the brushless motor 10. Accordingly, the opening and closing operations of the sliding door 1 is secured manually.

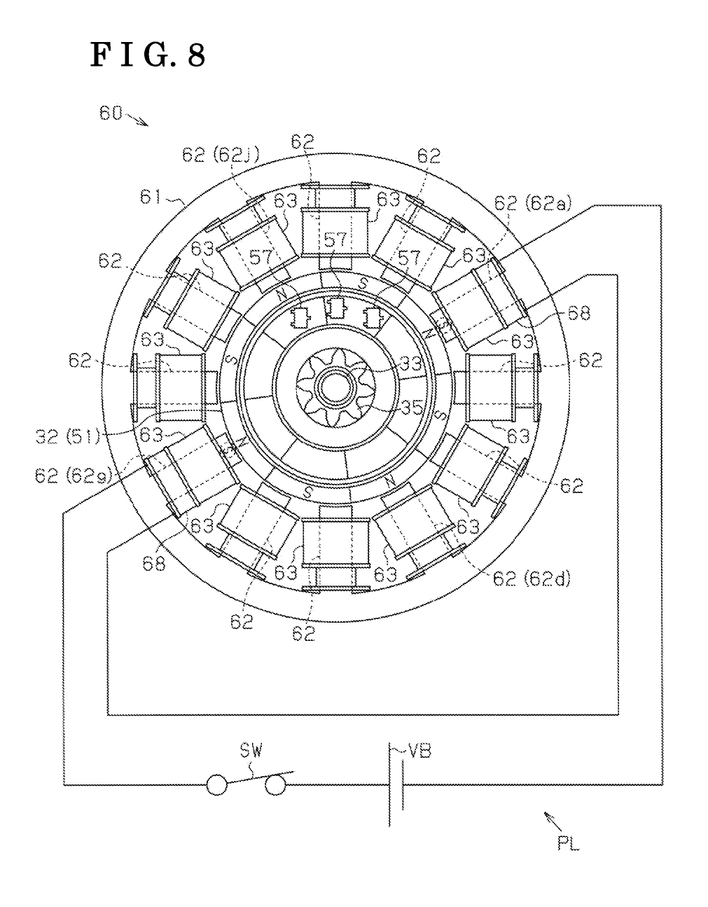

A second embodiment of the brushless motor 60 applied to the electrical actuator 11 of the power sliding door system 20 (the driving device for the opening and closing body for a vehicle) will be described referring to FIG. 8. For convenience of description, the same components as those described in the first embodiment are marked with the same reference numerals, and description of the components will not be repeated.

According to a brushless motor 60 of the second embodiment, as illustrated in FIG. 8, drive coils 63 are wound around all teeth 62 which configure a stator 61. Along with the drive coils 63, holding coils 68 are wound around two teeth 62a, 62g of the teeth 62 arranged to be spaced at 180 degrees in a circumferential direction of the stator 61.

According to the brushless motor 60 of the second embodiment, specifically, the drive coils 63 are wound close to the radially inner ends (radially inward) of the teeth 62. The holding coils 68 are wound closer to radially outer ends (radially outward) of the two teeth 62a, 62g than portions where the drive coils 63 are wound.

Further, according to the second embodiment, the magnet rotor 32 includes, for example, eight magnetic poles (the number of pairs of the magnetic poles is, for example, four) while the stator 61 includes, for example, twelve of the teeth 62. The same as the first embodiment, the holding coils 68 include the power supply line PL independently arranged from (the existed power supply line supplying the three-phase drive power to) the drive coils 63.

As described above, the brushless motor 60 of the second embodiment generates the electromagnetic attractive force for maintaining the magnet rotor 32 at the rotational position by supplying electricity to the holding coils 68, the rotational position where the radially inner ends of the teeth 62a, 62g around which the holding coils 68 are wound are configured to directly face against the magnetic pole (N pole) of the magnet rotor 32. Thus, the stopping position of the magnet rotor 32 may be maintained by restricting the rotation of the magnet rotor 32 efficiently with a simple configuration. Further, as the holding coils 68 are arranged without applying additional configurations, or additional components, the brushless motor 60 has advantages of wide application range.

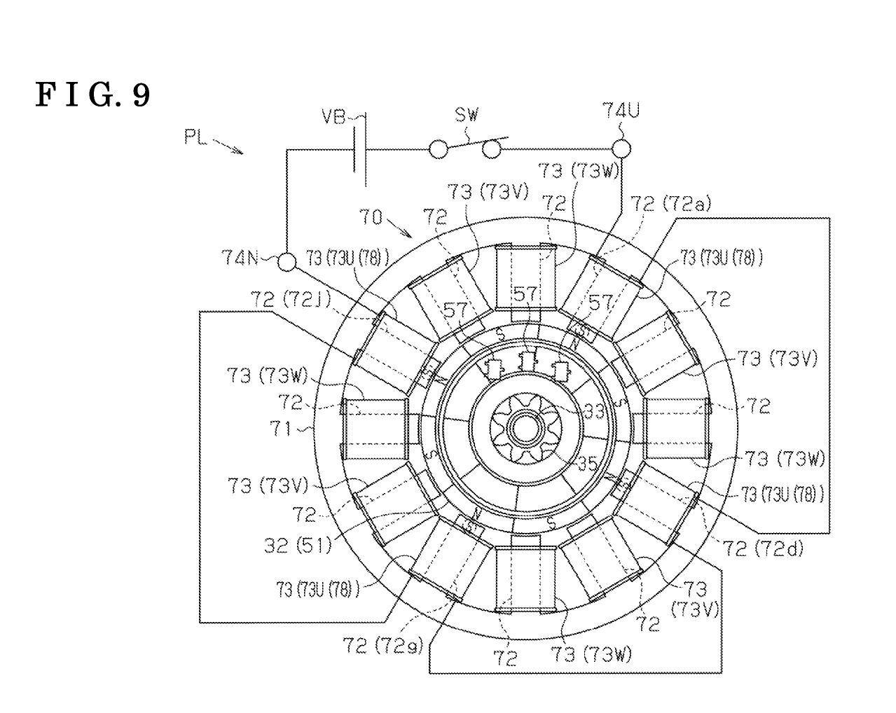

A third embodiment of the brushless motor 70 applied to the electrical actuator 11 of the power sliding door system 20 (the driving device for the opening and closing body for a vehicle) will be described referring to FIG. 9. For convenience of description, the same components as those described in the first embodiment are marked with the same reference numerals, and description of the components will not be repeated.

According to the brushless motor 70 of the third embodiment, as illustrated in FIG. 9, the same as the brushless motor 60 of the second embodiment, drive coils 73 are wound around all teeth 72 which configure a stator 71.

Specifically, the magnet rotor 32 includes, for example, eight magnetic poles (the number of pairs of the magnetic poles is, for example, four) while the stator 71 includes, for example, twelve of the teeth 72. The three-phase (U, V, W) drive coils 73 (73U, 73V, 73W) connected in star connection (Y connection) are wound around the teeth 72 in the order of U, V, and W in a clockwise direction illustrated in FIG. 9. According to the brushless motor 70 of the third embodiment, the drive coils 73 of a specific phase, in particular, U-phase drive coils 73U are applied as holding coils 78.

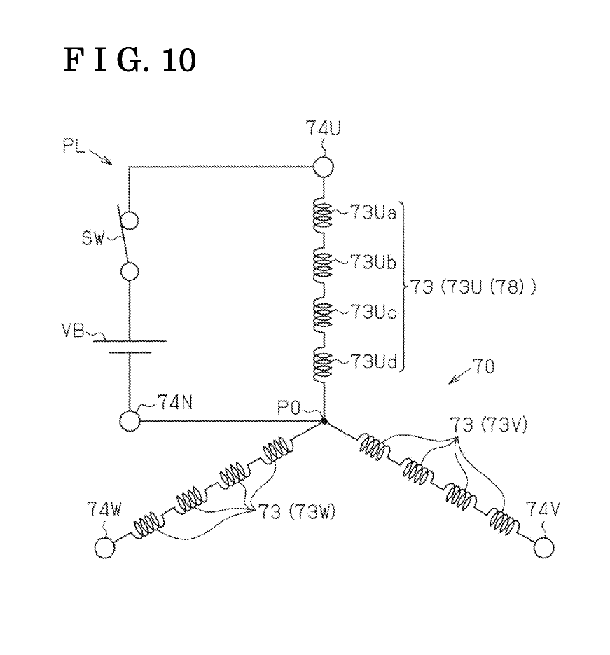

More specifically, according to the brushless motor 70 of the third embodiment, as illustrated in FIG. 10, the drive coils 73 of each phase (73U, 73V, 73W) are connected in series (per phase U, V, and W). The brushless motor 70 includes a neutral terminal 74N extending from a connection point, that is, a neutral point P0, of the three-phase drive coils 73 (73U, 73V, 73W). According to the third embodiment, by applying the neutral terminal 74N, the independently-arranged power supply line PL supplying DC power of the DC power supply VB to each of the drive coils 73U (from 73Ua to 73Ud), the serially-connected specific phase (U-phase), is formed.

That is, according to the brushless motor 70 including the drive coils 73 of each phase (73U, 73V, 73W) connected in star connection, the power supply line PL supplying power only to the drive coils 73 (73U) of the specific phase by connecting a neutral terminal 74N and a phase terminal (74U) of the specific phase (U phase) is formed. The three-phase drive power that rotates the magnet rotor 32 is supplied to each of the drive coils 73 via each of the phase terminals (74U, 74V, 74W).

According to the third embodiment, as illustrated in FIG. 9, the number of the teeth 72 (for example, n=12) is set to be a multiple number (for example, three times) of a number of pairs of the magnetic poles (for example, m=4). Accordingly, each of the U-phase drive coils 73U (from 73Ua to 73Ud) selected as a specific phase is wound around each of the teeth 72a, 72d, 72g, and 72j arranged to be spaced at 90 degree in the circumferential direction of the stator 31.

Thus, the teeth 72a, 72d, 72g, and 72j wound with the drive coils 73U (from 73Ua to 73Ud) are arranged to be spaced at an angular interval (90 degrees) corresponding to a value obtained by dividing the single rotation degrees (360 degrees) of the magnet rotor 32 by the number of pairs of the magnetic poles (m=4) of the magnet rotor 32. Accordingly, the teeth 72a, 72d, 72g, and 72j may be configured to directly face against the magnetic pole (N pole) of the magnet rotor 32 concurrently, or simultaneously. The brushless motor 70 of the third embodiment generates the electromagnetic attractive force for attracting the magnetic pole (S pole) formed at the radially inner ends of the teeth 72a, 72d, 72g, 72j and the magnetic pole (N pole) of the magnet rotor 32 one another at four positions arranged to be spaced at equal angular intervals in the circumferential direction of the stator 31 in a state where the radially inner ends of the teeth 72a, 72d, 72g, 72j of the stator 71 and the magnetic pole (N pole) of the magnet rotor 32 are configured to directly face against one another.

As described above, the brushless motor 70 of the third embodiment generates the electromagnetic attractive force for maintaining the magnet rotor 32 at the rotational position where the radially inner ends of the teeth 72a, 72d, 72g, 72j around which the specific phase drive coils 73 configuring the holding coils 78 are wound and the magnetic pole (N pole) of the magnet rotor 32 are configured to direct face against one another by supplying electricity to the holding coils 78. Thus, the stopping position of the magnet rotor 32 may be maintained by restricting the rotation of the magnet rotor 32 efficiently with a simple configuration.

When the braking control applying the drive coils 73 of the specific phase as the holding coils 78 is operated, a drive voltage of the brushless motor 70 may be favorably set to be lower than a drive voltage of the brushless motor 70 when the driving control is operated. Thus, the heat generated by supplying electricity may be refrained.

The aforementioned first, second and third embodiments may be modified as follows.

According to the aforementioned first, second and third embodiments, the brushless motor 10, 60, 70 for use in the electrical actuator 11 is applied to the power sliding door system 20 as the driving device for the opening and closing body for a vehicle. Alternatively, the first, second, and third embodiments may be applied to other driving devices for the opening and closing bodies for a vehicle, the driving devices such as a rear door, a luggage door or a trunk door arranged at the vehicle rear portion to perform opening and closing operations for opening and closing bodies other than the sliding door 1.

According to the first, second and third aforementioned embodiments, the magnet rotor 32 includes the first ring magnet 51 fixed at the outer circumferential surface of the rotor core 50. Alternatively, plural board-shaped (or arch-shaped) magnets may be fixed at the outer circumferential surface of the rotor core 50. Further, not only the brushless motor (SPM motor) including the surface magnet-type magnet rotor 32, but also a brushless motor (Interior Permanent Magnet motor, or IPM motor) including a buried magnet-type magnet rotor may be realized.

According to the aforementioned first, second and third embodiments, the inner-rotor type brushless motor 10, 60, 70 includes the magnet rotor 32 rotating at radially inward of the stator 31, 61, 71. Alternatively, an outer-rotor type brushless motor including a magnet rotor rotating at radially outward of the stator may be applied.

A Magnetic pole formed at the radially inner ends of the teeth 52, 62, 72 around which the holding coils 58, 68, 78 are wound may be N pole. In this case, a magnetic pole of the magnet rotor 32 attracting the magnetic pole (N pole) at the radially inner ends of the teeth 52, 62, 72 is S pole. That is, the magnetic pole formed at the radially inner ends of the teeth 52, 62, 72 around which the holding coils 58, 68, 78 are wound may be either S pole or N pole as long as the magnet rotor 32 is maintained at the rotational position where the radially inner ends of the teeth 52, 62, 72 and the magnetic poles of the magnet rotor 32 are configured to directly face against one another. The brushless motor may be configured such that teeth whose radially inner ends are magnetized in S pole and teeth whose radially inner ends are magnetized in N pole by supplying electricity to the holding coils 58, 68, 78 may be mixed.

However, considering a balance of the electromagnetic attractive force generated by supplying electricity to the holding coils 58, 68, 78, the radially inner ends of teeth around which holding coils 58, 68, 78 are wound may preferably be configured to directly face against the magnetic pole of the magnet rotor 32 concurrently, or simultaneously at plural positions arranged to be separated at equal angular interval in the circumferential direction of the stator 31.

The number of the magnetic poles of the magnet rotor 32 (the number of pairs of the magnetic poles) and the number (the slot number) of the teeth 52, 62, 72 configuring the stator 31, 61, 71 may be changed arbitrarily. However, the number of the teeth (n) may favorably be an integral multiple equal to or greater than two of a number of pairs of the magnet poles (m).

According to the aforementioned configuration, the plural teeth 52, 62, 72 arranged to be spaced at equal angular intervals in the circumferential direction of the stator 31, 61, 71 may be configured to directly face against the specific magnetic pole (N pole) of the magnet rotor 32 concurrently, or simultaneously. The electromagnetic attractive force may be generated to maintain the magnet rotor 32 at the rotational position in an efficient and well-balanced manner by the holding coils 58, 68, 78 being wound around the teeth 52, 62, 72.

According to the brushless motor 10 of the first embodiment, the second teeth 52B around which the drive coils 53 are not wound are wound with the holding coils 58. The holding coils 58 may favorably be wound around the second teeth 52B arranged to be spaced at angular intervals corresponding to a double amount of a value obtained by dividing the single rotation degrees (360 degrees) of the magnet rotor 32 by the number of pairs of the magnetic poles of the magnet rotor 32. Accordingly, the electromagnetic attractive force may be generated to maintain the magnet rotor 32 at the rotational position where the radially inner ends of the second teeth 52B around which the holding coils 58 are wound and the magnetic pole (N pole) of the magnet rotor 32 are configured to directly face against one another.

According to the aforementioned first, second and third embodiments, the speed reduction mechanism 22 configuring the electrical actuator 11 is formed by the disc-shaped plural gears being meshed with one another. Alternatively, the configuration of the speed reduction mechanism 22 may be changed, or modified arbitrarily as long as the speed reduction mechanism 22 may transmit the reverse input rotation inputted from the output portion of the speed reduction mechanism 22 to the input portion of the speed reduction mechanism 22 connected to the brushless motor 10. For example, teeth of the gear may be formed in a spur gear shape. Alternatively, the speed reduction mechanism 22 may apply a gear such as a crown gear or a face gear. A speed reduction mechanism with high transmission efficiency may be formed by applying gears including a planetary gear.

The skew magnetization may not be applied to each of the magnetic poles of the magnet rotor 32. However, when considering a smooth manual operation of the sliding door 1, cogging torque generated at the brushless motor 10, 60, 70 is desirable to be reduced.

The number of the teeth 52, 62, 72 around which the holding coils 58, 68, 78 are wound may be changed arbitrarily. For example, according to the brushless motor 60 of the second embodiment, the holding coils 68 may be wound around the teeth 62a, 62d, 62g, 62j arranged to be spaced at the angular intervals (90 degrees) corresponding to the value obtained by dividing the single rotation degrees (360 degrees) of the magnet rotor 32 by the number of pairs of the magnetic poles (n=4) of the magnet rotor 32 (see FIG. 8). Accordingly, the electromagnetic attractive force may be generated at four positions arranged to be spaced at equal angular intervals in the circumferential direction of the stator 31, the four positions where the radially inner ends of the teeth 62a, 62d, 62g, 62j and the magnetic pole (N pole) of the magnet rotor 32 are configured to directly face against one another to maintain the rotational position of the magnet rotor 32 efficiently in a well-balanced manner.

According to the brushless motor 70 of the third embodiment, a part of the drive coils from 73Ua to 73Ud corresponding to the specific phase may be applied as the holding coils 78 (see FIGS. 9 and 10). For example, two of the drive coils 73U wound around two of the teeth 72a, 72g arranged to be separated at 180 degrees in the circumferential direction of the stator 31 may be applied as the holding coils 78. Under the aforementioned configuration, the electromagnetic attractive force may be generated at two positions arranged to be spaced at equal angular intervals in the circumferential direction of the stator 31, the two positions where the radially inner ends of the teeth 72a, 72g and the magnetic pole (N pole) of the magnet rotor 32 are configured to directly face against one another to maintain the rotational position of the magnet rotor 32 efficiently in a well-balanced manner.

According to the brushless motor 10 of the first embodiment, the holding coils 58 are wound around only the second teeth 52B (52Ba, 52Bd) around which the drive coils 53 are not wound. Alternatively, the first teeth 52A around which the drive coils 53 and the holding coils 58 are both wound may be included as long as the electromagnetic attractive force is generated at the rotational position of the magnet rotor 32 to maintain the magnet rotor 32, the rotational position where the radially inner ends of the teeth 52 around which the holding coils 58 are wound are configured to directly face against the magnetic pole of the magnet rotor 32.

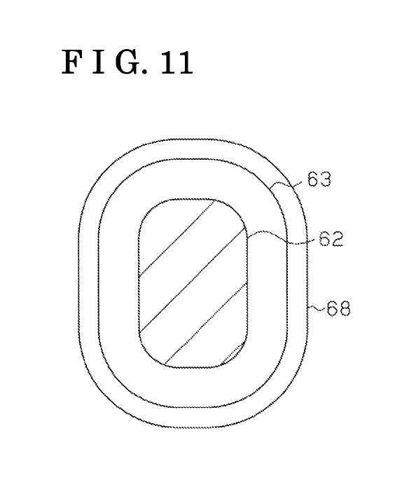

According to the second embodiment, the drive coils 63 are wound around the radially inner ends of each of the teeth 62 while the holding coils 68 are wound around the outer ends (radially outer ends) of the teeth 62 than portions where the drive coils 63 are wound. Alternatively, as illustrated in FIG. 11, the drive coil 63 and the holding coil 68 may be overlapped one another to be wound around each of the teeth 62.

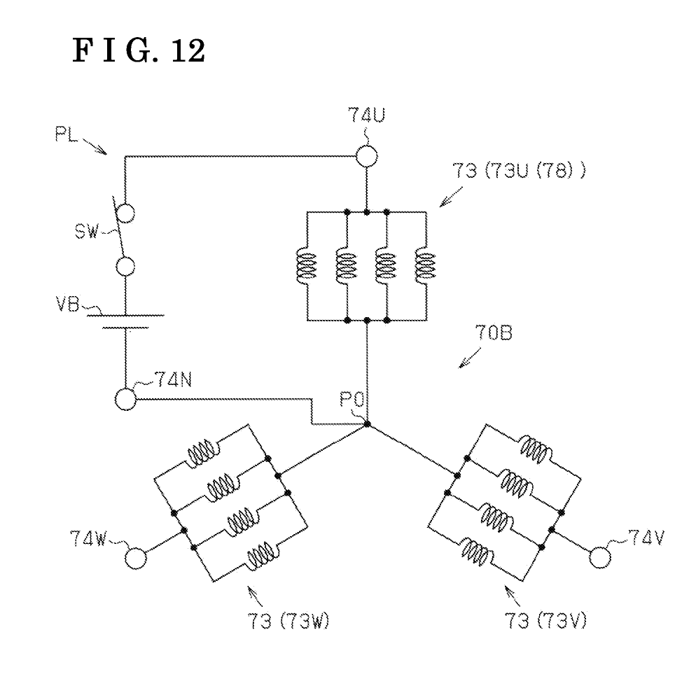

According to the third embodiment, the independently-arranged electric power supply PL supplying DC power of the DC power supply VB to the drive coils 73U (73Ua to 73Ud) of the serially-connected specific phase (U-phase) is formed. Alternatively, as illustrated in FIG. 12, the motor 70B in which the drive coils 73 of each phase are connected in parallel per phase may be applied. That is, according to the aforementioned configuration, the independently-arranged electric power supply line PL supplying DC power of the DC power supply VB to the drive coils 73 of the specific phase may be formed as long as the drive coils 73 are connected in star connection.

Further, V-phase and W-phase may be replaced with U-phase for as the specific phase.

Next, technical ideas according to the aforementioned first, second and third embodiments as well as the effects and the advantages will be described.

First, the number of the teeth 52, 62, 72 is integral multiple equal to or greater than 2 of the number of pairs of the magnetic poles formed at the magnet rotor 32. The holding coils 58. 68, 78 are wound around the plural teeth 52, 62, 72 arranged to be spaced at equal angular intervals corresponding to the value obtained by dividing the single rotation degrees (360 degrees) of the magnet rotor 32 by the number of pairs of the magnetic poles of the magnet rotor 32.

Second, the number of the teeth 52, 62, 72 is integral multiple equal to or greater than 2 of the number of pairs of the magnetic poles formed at the magnet rotor 32. The holding coils 58, 68, 78 are wound around the aforementioned plural second teeth 52B arranged to be spaced at equal angular intervals corresponding to a double amount of a value obtained by dividing the single rotation degrees (360 degrees) of the magnet rotor 32 by the number of pairs of the magnetic poles of the magnet rotor 32.

According to the aforementioned construction, the electromagnetic attractive force may be generated to maintain the magnet rotor 32 at the rotational position in a well-balanced manner at the plural portions in the circumferential direction of the stator 31, the rotational position where the radially inner ends of the teeth 52, 62, 72 around which the holding coils 58, 68, 78 are wound and the magnetic pole of the magnet rotor 32 are configured to directly face against one another. As a result, the stopping position of the magnet rotor 32 may be maintained by restricting the rotation of the magnet rotor 32 efficiently.

According to the aforementioned embodiment, the brushless motor 10, 60, 70 includes the magnet rotor 32 including the first rotary shaft 33 to be rotatable about the first rotary shaft 33, the stator 31, 61, 71 including the plural teeth 52, 62, 72 facing against the magnet rotor 32, the plural drive coils 53, 63, 73 being wound around the teeth 52, 62, 72 and being supplied with the three-phase drive power to rotate the magnet rotor 32, and the plural holding coils 58, 68, 78 being wound around the teeth 52, 62, 72 and including the independently-arranged power supply line PL, in which the holding coils 58, 68, 78 are arranged to generate the electromagnetic attractive force to maintain the magnet rotor 32 at the rotational position where the radially inner ends of the teeth 52, 62, 72 around which the holding coils 58, 68, 78 are wound and the magnetic pole of the magnet rotor 32 are configured to directly face against one another by supplying electricity to the holding coils 58, 68, 78 via the power supply line PL.

According to the aforementioned structure, the electromagnetic attractive force attracting the magnetic pole (for example, S pole) formed at the radially inner ends of the teeth 52, 62, 72 around which the holding coils 58, 68, 78 are wound and the magnetic pole (for example, N pole) of the magnet rotor 32 one another by supplying electricity to the holding coils 58, 68, 78 may be maximized at the rotational position of the magnet rotor 32, the rotational position where the radially inner ends of the teeth 52, 62, 72 and the magnetic pole of the magnet rotor 32 are configured to directly face against one another. Thus, according to the aforementioned structure, the stopping position of the magnet rotor 32 may be maintained efficiently by restricting the rotation of the magnet rotor 32. Compared to the construction of the known sliding door which includes the mechanical lock device, the sliding door 1 is configured with a simple configuration.

According to the aforementioned brushless motor 10, the stator 31 includes the first teeth 52A around which the drive coils 53 are wound and the second teeth 52B, 52Ba, 52Bd around which the drive coils 53 are not wound and the holding coils 58 are wound and the first teeth 52A and the second teeth 52B, 52Ba, 52Bd are arranged alternately in the circumferential direction of the stator 31.

Compared to a known brushless motor in which motor coils are wound around all the teeth, the brushless motor 10 of the aforementioned construction may reduce the number of the components and the process for winding and connecting coils while maintaining the output properties (for example, motor torque or torque ripple) substantially the same as output properties of the known brushless motor. By winding the holding coils 58 to the second teeth 52B, 52Ba, 52Bd which are not wound with the drive coils 53, the brushless motor 10 may avoid a size increase of the device caused by the winding of the holding coils 58.

According to the aforementioned brushless motor 60, the stator 61 includes the teeth 62a, 62g around which the holding coils 68 are wound along with the drive coils 63.

According to the aforementioned structure, as the holding coils 68 are arranged without applying additional configurations, or additional components, the brushless motor 60 has advantages of wide application range.

According to the aforementioned brushless motor 70, the three-phase drive coils 73 are connected in a star connection and the drive coils 73 of the specific phase are applied as the holding coils 78.

According to the aforementioned structure, the electromagnetic attractive force may be generated to maintain the magnet rotor 32 at the rotational position efficiently with a minimum additional configuration, or a minimum additional component required to form the independently-arranged power supply line PL without including dedicated holding coils 58, 68.

According to the aforementioned brushless motor 10, 60, 70, the number of the teeth 52, 62, 72 is the integral multiple equal to or greater than two of the number of pairs of the magnetic poles formed at the magnet rotor 32.

According to the aforementioned structure, the plural teeth 52, 62, 72 directly facing against the magnetic pole of the magnet rotor 32 concurrently, or simultaneously are existed to be spaced at the equal angular intervals in the circumferential direction of the stator 31. Thus, the electromagnetic attractive force may be generated to maintain the magnet rotor 32 at the rotational position efficiently in a well-balanced manner by the holding coils 58, 68, 78 being wound with the teeth 52, 62, 72 that are configured to directly face against the magnetic pole of the magnet rotor 32 concurrently, or simultaneously.

According to the aforementioned embodiment, the electrical actuator 11 includes the brushless motor 10, 60, 70 including the magnet rotor 32 including the first rotary shaft 33 to be rotatable about the first rotary shaft 33, the stator 31, 61, 71 including the plural teeth 52, 62, 72 facing against the magnet rotor 32, the plural drive coils 53, 63, 73 being wound around the teeth 52, 62, 72 and being supplied with the three-phase drive power to rotate the magnet rotor 32, and the plural holding coils 58, 68, 78 being wound around the teeth 52, 62, 72 and including the independently-arranged power supply line PL, in which the holding coils 58, 68, 78 are arranged to generate the electromagnetic attractive force to maintain the magnet rotor 32 at the rotational position where the radially inner ends of the teeth 52, 62, 72 around which the holding coils 58, 68, 78 are wound and the magnetic pole of the magnet rotor 32 are configured to directly face against one another by supplying electricity to the holding coils 58, 68, 78 via the power supply line PL, and the speed reduction mechanism 22 decelerating the rotation of the brushless motor 10 for an output and transmitting the reverse input rotation inputted from the end 37a of the third rotary shaft 37, that is the output portion of the speed reduction mechanism 22 to the first pinion gear 35, that is the input portion of the speed reduction mechanism 22 connected to the brushless motor 10.

According to the aforementioned structure, the rotation of the brushless motor 10, 60, 70 may be restricted by supplying electricity to the holding coils 58, 68, 78. Accordingly, the stopping position of the drive object may be maintained efficiently. By stopping energization to the holding coils 58, 68, 78, the rotation of the brushless motor 10, 60, 70 may be permitted. Thus, smooth and free operation of the drive object by the external input may be secured.

According to the aforementioned embodiment, the power sliding door system 20 includes the electrical actuator 11 including the brushless motor 10, 60, 70 including the magnet rotor 32 including the first rotary shaft 33 to be rotatable about the first rotary shaft 33, the stator 31, 61, 71 including the plural teeth 52, 62, 72 facing against the magnet rotor 32, the plural drive coils 53, 63, 73 being wound around the teeth 52, 62, 72 and being supplied with the three-phase drive power to rotate the magnet rotor 32, and the plural holding coils 58, 68, 78 being wound around the teeth 52, 62, 72 and including the independently-arranged power supply line PL, in which the holding coils 58, 68, 78 are arranged to generate the electromagnetic attractive force to maintain the magnet rotor 32 at the rotational position where the radially inner ends of the teeth 52, 62, 72 around which the holding coils 58, 68, 78 are wound and the magnetic pole of the magnet rotor 32 are configured to directly face against one another by supplying electricity to the holding coils 58, 68, 78 via the power supply line PL, and the speed reduction mechanism 22 decelerating the rotation of the brushless motor 10, 60, 70 for an output and transmitting the reverse input rotation inputted from the end 37a of the third rotary shaft 37, that is the output portion of the speed reduction mechanism 22 to the first pinion gear 35, that is the input portion of the speed reduction mechanism 22, the first pinion gear 35 connected to the brushless motor 10, 60, 70, in which the sliding door 1 is operated to be open and closed.

According to the aforementioned structure, the rotation of the brushless motor 10, 60, 70 may be restricted by supplying electricity to the holding coils 58, 68, 78. The rotation of the brushless motor 10, 60, 70 may be permitted by stopping energization to the holding coils 58, 68, 78. Accordingly, the stopping position of the vehicle opening and closing body (for example, a vehicle door or a trunk door) which is driven by the electrical actuator 11 is maintained efficiently while securing the manual operation for opening and closing the vehicle opening and closing body smoothly.

According to the aforementioned disclosure, the stopping position of the vehicle opening and closing body is maintained efficiently with a simple configuration.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A brushless motor, comprising:
a magnet rotor including a rotary shaft to be rotatable about the rotary shaft;
a stator including a plurality of teeth facing against the magnet rotor;
a plurality of drive coils being wound around the teeth and being supplied with a three-phase drive power to rotate the magnet rotor; and
a plurality of holding coils being wound around the teeth and including an independently-arranged power supply line, wherein the holding coils are arranged to generate an electromagnetic attractive force to maintain the magnet rotor at a rotational position where ends of the teeth around which the holding coils are wound and a magnetic pole of the magnet rotor are configured to directly face against one another by supplying electricity to the holding coils via the power supply line.

2. The brushless motor according to claim 1, wherein the stator includes a first teeth around which the drive coils are wound and a second teeth around which the drive coils are not wound and the holding coils are wound and the first teeth and the second teeth are arranged alternately in a circumferential direction of the stator.

3. The brushless motor according to claim 1, wherein the stator includes the teeth around which the holding coils are wound along with the drive coils.

4. The brushless motor according to claim 1, wherein the three-phase drive coils are connected in a star connection and the drive coils of a specific phase are applied as the holding coils.

5. The brushless motor according to the claim 1, wherein a number of the teeth is an integral multiple equal to or greater than two of a number of pairs of the magnetic poles formed at the magnet rotor.

6. An electrical actuator comprising:
a brushless motor including a magnet rotor including a rotary shaft to be rotatable about the rotary shaft, a stator including a plurality of teeth facing against the magnet rotor, a plurality of drive coils being wound around the teeth and being supplied with a three-phase drive power to rotate the magnet rotor, and a plurality of holding coils being wound around the teeth and including an independently-arranged power supply line, wherein the holding coils are arranged to generate an electromagnetic attractive force to maintain the magnet rotor at a rotational position where ends of the teeth around which the holding coils are wound and a magnetic pole of the magnet rotor are configured to directly face against one another by supplying electricity to the holding coils via the power supply line; and
a speed reduction mechanism decelerating a rotation of the brushless motor for an output and transmitting a reverse input rotation inputted from an output portion of the speed reduction mechanism to an input portion of the speed reduction mechanism, the input portion connected to the brushless motor.

7. A driving device for an opening and closing body for a vehicle, comprising:
an electrical actuator including a brushless motor including a magnet rotor including a rotary shaft to be rotatable about the rotary shaft, a stator including a plurality of teeth facing against the magnet rotor, a plurality of drive coils being wound around the teeth and being supplied with a three-phase drive power to rotate the magnet rotor, and a plurality of holding coils being wound around the teeth and including an independently-arranged power supply line, wherein the holding coils are arranged to generate an electromagnetic attractive force to maintain the magnet rotor at a rotational position where ends of the teeth around which the holding coils are wound and a magnetic pole of the magnet rotor are configured to directly face against one another by supplying electricity to the holding coils via the power supply line, and a speed reduction mechanism decelerating a rotation of the brushless motor for an output and transmitting a reverse input rotation inputted from an output portion of the speed reduction mechanism to an input portion of the speed reduction mechanism, the input portion connected to the brushless motor, wherein the opening and closing body for a vehicle is operated to be open and closed.
